(19) United States
(12) Patent Application Publication
(10) Pub. No.: US 2020/0039434 A1
(43) Pub. Date: Feb. 6, 2020

(54) METHOD AND SYSTEM FOR DETERMINING AND DISPLAYING A WADING SITUATION

(71) Applicant: Robert Bosch GmbH, Stuttgart (DE)

(72) Inventor: Jesse Sharp, Caulfield North (AU)

(21) Appl. No.: 16/527,573

(22) Filed: Jul. 31, 2019

(30) Foreign Application Priority Data
Jul. 31, 2018 (DE) 102018212779.4

(51) Int. Cl. B60Q 9/00; B60R 1/12

(52) U.S. Cl. CPC B60Q 9/00; G01S 13/931; B60R 2001/1223; B60R 1/12

(57) ABSTRACT

A driver assistance system, for determining a fording situation of a vehicle, includes: exactly one distance sensor for determining an instantaneous distance from an installation position of the distance sensor to a water surface, and in particular for determining an instantaneous fording depth of the vehicle; a first measuring device for determining an instantaneous roll angle of the vehicle; a second measuring device for determining an instantaneous pitch angle of the vehicle; and a processing unit coupled to the distance sensor, the first measuring device, and the second measuring device, and that is configured to determine an instantaneous water surface plane as a function of the instantaneous distance, the instantaneous roll angle, and the instantaneous pitch angle of the vehicle.

### CROSS-REFERENCE TO RELATED APPLICATIONS

The present application claims priority under 35 U.S.C. § 119 to DE 10 2018 212 779.4, filed in the Federal Republic of Germany on Jul. 31, 2018, the content of which is hereby incorporated by reference herein in its entirety.

### FIELD OF THE INVENTION

The present invention relates to a driver assistance system, to a method for determining a fording situation, and to a vehicle including a driver assistance system, an instantaneous fording depth of the vehicle being determined.

### BACKGROUND

Off-road vehicles, such as all-terrain vehicles or so-called SUVs (“sport utility vehicles”), are designed to cross bodies of water. When the vehicle has to become immersed in the water to a certain degree in the process, this is referred to as a “fording process.” Such a maneuver requires a lot of caution and prudence from the driver, since the driver usually does not known how deep is the body of water to be crossed, nor what the condition of the terrain beneath the water surface is. This problem is further exacerbated by adverse environmental conditions such as darkness, fog, rain, or polluted water. Conventionally, the recommendation has been for the driver to leave the vehicle prior to crossing the body of water and to check the water depth and the terrain conditions beneath the water surface using suitable aids.

Assistance systems which make it simpler for the driver to handle a fording process are known from the related art. For example, a vehicle is described in WO 2012/123555 A1 which includes two ultrasonic sensors, which are each attached to the side mirrors of the vehicle and which detect the distance from a water surface beneath the side mirrors, and a water contact sensor situated on the underbody of the vehicle.

WO 2012/080435 A1, WO 2012/080437 A1, and WO 2012/080438 A1 describe vehicles which include display systems representing a side view of the vehicle, together with a measured instantaneous fording depth and a maximum permissible fording depth (fording limit). The instantaneous fording depth and the fording limit are each shown as straight lines. The maximum fording depth, i.e., the fording limit, usually results from design circumstances of the particular vehicle. For example, air intakes of an internal combustion engine must not end up underwater. It is possible to display to the driver by a percentage value how deep the vehicle is presently situated under water in relation to the fording limit.

### SUMMARY

The present invention is directed to gathering more precise pieces of information about the instantaneous fording situation of a vehicle, so that instantaneous information and optionally a representation of the instantaneous fording situation are made available to the driver, even while limiting to a minimum the number of required sensors.

The present invention is based on the idea that a single distance sensor designed and oriented for the purpose of determining an instantaneous distance from a known installation position of the distance sensor on the vehicle to a water surface, in particular perpendicularly downward, is sufficient for determining an instantaneous water surface plane relative to the vehicle together with pieces of information about the longitudinal and lateral inclination (pitch angle and roll angle) of the vehicle, which can be ascertained, for example, using an existing ESP system by evaluating signals from acceleration sensors. In particular, assuming that the water surface is a plane, this plane can be unambiguously determined in a coordinate system of the vehicle by the measured variables detected according to the present invention.

According to an example embodiment of the present invention, a driver assistance system is provided, which is designed to determine such a fording situation of a vehicle. The driver assistance system includes exactly one distance sensor for determining an instantaneous distance from an installation position of the distance sensor to a water surface. From this distance, in conjunction with the known installation position of the distance sensor on the vehicle and the known orientation of the measuring range of the distance sensor (e.g., perpendicularly downward), it is possible to determine an instantaneous fording depth of the vehicle. The distance sensor can be designed as an ultrasonic sensor or a LIDAR sensor or a radar sensor, for example.

Furthermore, the driver assistance system includes a first measuring device for determining an instantaneous roll angle of the vehicle. The roll angle describes an inclination about a longitudinal axis of the vehicle. The first measuring device can include an acceleration sensor, for example.

Furthermore, the driver assistance system includes a second measuring device for determining an instantaneous pitch angle of the vehicle. The pitch angle describes an inclination about a lateral axis of the vehicle. The second measuring device can include an acceleration sensor and/or wheel speed sensors, for example.

Furthermore, the driver assistance system includes a processing unit coupled to the distance sensor, the first measuring device, and the second measuring device. The processing unit is designed to determine an instantaneous water surface plane relative to the vehicle as a function of the measured distance, the instantaneous roll angle, and the instantaneous pitch angle of the vehicle.

The driver assistance system can furthermore include a display unit designed to represent the instantaneous water surface plane relative to the vehicle.

In an example embodiment, the driver assistance system moreover includes at least one camera designed to detect at least one specific feature of the body of the vehicle. By evaluating the detected feature, it is identifiable whether a portion of the body including the feature is situated at or under the water surface. As a result of this evaluation, it is thus possible to establish with increased accuracy where the instantaneous water surface is situated relative to the vehicle. This information can moreover also be taken into consideration in the calculation of the instantaneous water surface plane. The detected feature can be a feature, for example, which, due to its coloring and/or shape, can be identified with high reliability by corresponding image processing algorithms. For example, the feature has a high contrast. For example, the feature is an edge of the body or a decorative element.

In an example embodiment of the present invention, the driver assistance system furthermore includes a memory unit, respective assigned fording limits being stored in the memory unit for a multitude of specific positions on the vehicle. The processing unit is designed to determine for each of the specific positions whether the assigned fording limit is above or below the water surface plane.

The specific positions can be, for example, air intakes or other positions where an ingress of water into the vehicle is possible, which could result in damage to or operating failure of the vehicle, such as windows or vent holes.

Furthermore, the processing unit is preferably designed to determine the instantaneous distance of the assigned fording limit from the instantaneous water surface plane for each of the specific positions.

Furthermore, the display unit is preferably designed to output a warning if the instantaneous distance of a specific position from the assigned fording limit drops below a specific limiting value. Furthermore, the display unit is preferably designed to display, in particular in real time, a perspective or three-dimensional representation of the vehicle, together with a perspective or three-dimensional representation of the instantaneous water surface plane. The warning can take place, for example, in that a representation of the vehicle is displayed on the display unit, and the affected specific position is highlighted in color and/or by another visual marking. As an alternative or in addition, an acoustic and/or a visual warning can be output, for example a voice message that names the affected specific position.

In particular, the display unit is designed to represent an intersecting line of the vehicle outer contour with the instantaneous water surface plane in a visually highlighted manner, and to represent the instantaneous distances of the specific positions from the assigned fording limits.

An example embodiment of the present invention is directed to a vehicle that includes the described driver assistance system.

An example embodiment of the present invention is directed to a method for determining a fording situation of a vehicle that includes one distance sensor for determining an instantaneous distance from an installation position of the distance sensor to a water surface. The distance sensor is preferably designed to determine the distance by a time of flight measurement.

Preferably, the exactly one distance sensor is situated in an elevated position on the vehicle.

In an example embodiment of the present invention, the exactly one distance sensor is situated on a side mirror of the vehicle, in particular in such a way that it is able to measure the distance from a water surface perpendicularly downward.

For example, the distance sensor can be situated at the rear of the vehicle, in particular in the area of the roof.

For example, the distance sensor can be situated at the front of the vehicle, in particular in the area of the hood.

The installation height of the distance sensor on the vehicle is, in particular, known or established.

The vehicle includes a first measuring device for determining an instantaneous roll angle of the vehicle. For example, the roll angle can be determined by reading out an acceleration sensor of an ESP system.

The vehicle includes a second measuring device for determining an instantaneous pitch angle of the vehicle. For example, the pitch angle can be determined by determining the difference between an acceleration of the vehicle in the forward direction measured by the acceleration sensor and an acceleration determined using the wheel speed sensors. The difference corresponds to the acceleration caused by the inclination of the roadway, i.e., by the gravitation, from which, in turn, the instantaneous pitch angle can be derived.

An instantaneous water surface plane relative to the vehicle is determined as a function of the distance, the instantaneous roll angle, and the instantaneous pitch angle of the vehicle.

In an example embodiment of the present invention, the driver assistance system can moreover include at least one camera, which is designed to detect at least one specific feature of the body of the vehicle, it being possible to identify by an evaluation of the detected feature whether a portion of the body including the feature is situated below the water surface. For this purpose, for example, it is possible to detect using methods of digital image processing and/or a comparison to reference images whether the feature is visible or whether, for example, it is visible in a distorted manner since it is already partially immersed in the water. Since the position of the feature thus detected on the vehicle is known, it is thus possible to establish whether this position of the vehicle is already situated in or under water, and the accuracy of the determination of the water surface plane relative to the vehicle can thereby be improved. The feature is, in particular a feature which due to its coloring and/or shape can be identified with high reliability by corresponding image processing algorithms. For example, the feature has a high contrast. For example, the feature is an edge of the body or a decorative element.

Using a display unit of the vehicle, the instantaneous water surface plane relative to the vehicle can be represented.

Preferably, respective assigned fording limits are stored for a multitude of specific positions on the vehicle, for example in a memory unit of the vehicle. Now that the instantaneous water surface plane is known, it is possible to determine for each of the specific positions whether the assigned fording limit is above or below the instantaneous water surface plane. Preferably, the instantaneous distance of the assigned fording limit from the instantaneous water surface plane is determined for each of the specific positions. If the instantaneous distance of a specific position from the assigned fording limit drops below a specific limiting value, a warning can be output, so that the driver is able to respond before the vehicle is damaged by penetrating water.

An example embodiment of the present invention is directed to a method in which a perspective or three-dimensional representation of the vehicle, together with a perspective or three-dimensional representation of the instantaneous water surface plane, is displayed to the driver on a corresponding display unit, in particular in real time.

In particular, an intersecting line of the vehicle outer contour with the instantaneous water surface plane can be represented in a visually highlighted manner, and the instantaneous distances of the specific positions from the assigned fording limits can be displayed. In this way, a particularly intuitive representation of the instantaneous fording situation is achieved for the driver, in which the driver can directly discern whether and where on the vehicle there is a risk of water ingress.

An example embodiment of the present invention is directed to a computer program product including program code means for carrying out the described method if the computer program product, which is stored on a computer-readable medium, runs on a processing unit.

### BRIEF DESCRIPTION OF THE DRAWING

FIG. 1a schematically shows, together with a water surface plane, a front view of a vehicle including a driver assistance system according to an example embodiment of the present invention.

FIG. 1b schematically shows, together with the water surface plane, a side view of the vehicle according to an example embodiment of the present invention.

FIG. 2 is a block diagram that schematically represents a computer program for carrying out a method according to an example embodiment of the present invention.

### DETAILED DESCRIPTION

In the following description, identical elements are denoted by the same reference numerals, a repeated description of these elements being dispensed with, if necessary. The figures only schematically represent the subject matter of the present invention.

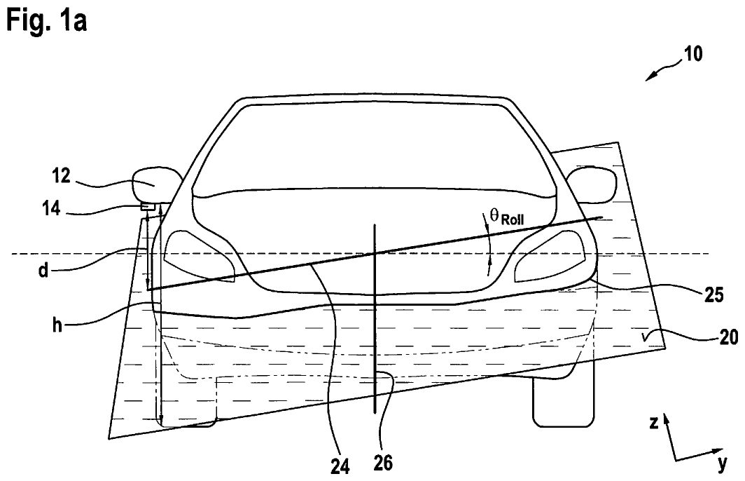

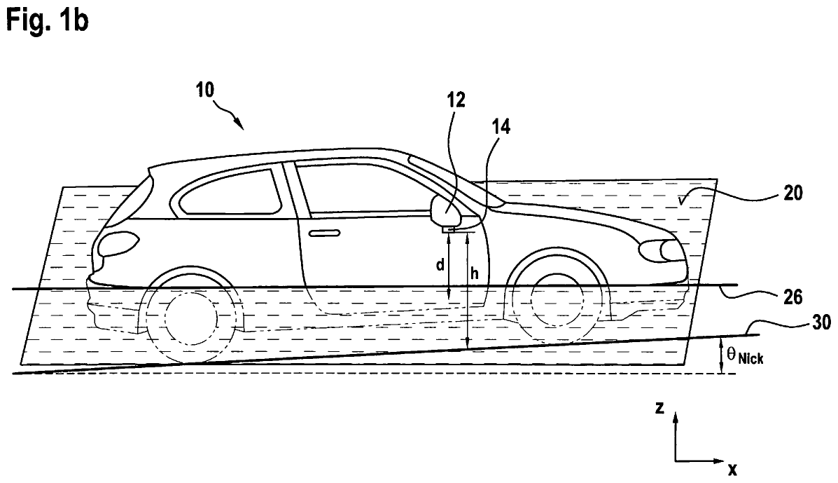

FIGS. 1a and 1b schematically show a vehicle 10 including a driver assistance system according to an example embodiment of the present invention, together with a water surface plane 20, which was determined using the driver assistance system. The vehicle includes a downwardly oriented distance sensor 14 on an exterior mirror 12. Distance sensor 14 is designed as an ultrasonic sensor. Water surface plane 20 is determined in that first a distance d from the water surface is measured by distance sensor 14. Together with the known installation position h of distance sensor 14, a local fording depth can be determined. The lateral inclination (roll angle θ_{Roll}) of vehicle 10 is determined using an acceleration sensor (not shown). Together with measured distance d from side mirror 12 to the water surface, a line 24 can be determined. Instantaneous water surface plane 20 is moreover determined by the pitch angle of vehicle 10.

In the example shown in FIG. 1b, vehicle 10 is moving on an upwardly inclined roadway 30. When vehicle 10 is moving in x direction at a uniform speed or is stationary, a measurable acceleration of vehicle 10 in x direction is only caused by the inclination of roadway 30, i.e, by the gravitational force. In this case, pitch angle θ_{Pitch} corresponds to the angle of inclination of roadway 30. When vehicle 10 is moving in an accelerated manner or is braking (positive or negative acceleration by motor/engine power), a corresponding deviation of pitch angle θ_{Pitch} results. Using suitable sensors, for example using wheel speed sensors and an acceleration sensor (not shown), instantaneous pitch angle θ_{Pitch} can thus be determined and, derived therefrom, a straight line 26 can be ascertained. For example, pitch angle θ_{Pitch} can be determined by determining the difference between an acceleration of vehicle 10 in the forward direction (x direction) measured by the acceleration sensor and an acceleration determined using the wheel speed sensors. The difference corresponds to the acceleration caused by the inclination of the roadway, i.e., by the gravitation, from which, in turn, instantaneous pitch angle θ_{Pitch} can be derived.

Water surface plane 20 can now be determined by shifting straight line 26 in parallel to the horizontal (in z direction) until it intersects line 24. The two lines 24 and 26 now span water surface plane 20. Moreover, an intersecting line 25 of the vehicle outer contour with the instantaneous water surface plane can be determined.

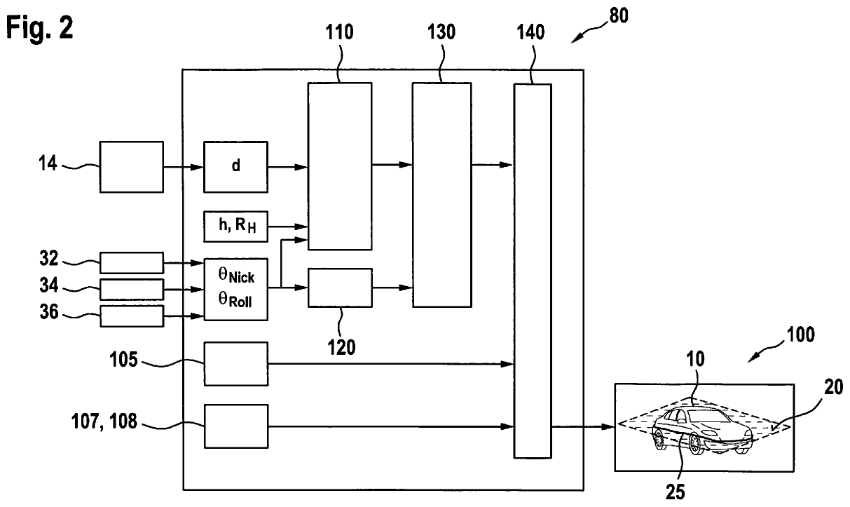

FIG. 2 shows a block diagram of procedure 80 of a method according to the present invention, for example for executing a computer program on a processing unit of a driver assistance system according to the present invention. Using distance sensor 14, a distance signal d is generated, which describes the distance of sensor 14 from the water surface. This can be the result from an individual measurement or, for example, the average value from multiple chronologically consecutive measurements. Furthermore, using an acceleration sensor 32, instantaneous roll angle θ_{Roll} is determined. From distance signal d, the known installation position h of distance sensor 14 and instantaneous roll angle θ_{Roll}, a first vector spanning the instantaneous water surface plane and formed by connecting line 24 is generated in program part 110. If necessary, a variable vehicle height R_{H} can be taken into consideration. Pitch angle θ_{Pitch} of vehicle 10 is determined from measuring data of an acceleration sensor 34 and measuring data of wheel speed sensors 36. From pitch angle θ_{Pitch}, a second vector spanning instantaneous water surface plane 20 and represented by line 26 is generated in program part 120. From the vectors, instantaneous water surface plane 20 is determined in a coordinate system of vehicle 10 in program step 130.

For a representation and display, furthermore a three-dimensional model 105 of the vehicle, in particular of the outer contour of the vehicle, is provided. This model can be simplified compared to the real vehicle. Moreover, data 107 regarding specific positions on vehicle 10 are provided, as well as fording limits 108 individually assigned to these positions. The specific positions encompass, for example, positions on vehicle 10 at which no water should penetrate, e.g., positions of aspiration ports, air intakes, windows, etc. Fording limits 108 are, in particular, different from one another. Vehicle model 105, data 107 regarding the specific positions on vehicle 10, and fording limits 108 assigned to the specific positions are, for example, stored in a memory unit of the driver assistance system and retrieved during implementation.

In program step 140, a representation 100 is generated from data 105, 107, and 108 of vehicle 10 and the calculated water surface plane 20, which graphically represents the instantaneous fording situation of vehicle 10 to the driver on a corresponding display system. In this example, vehicle 10, instantaneous water surface plane 20, and a contour line 25 representing the intersecting line of water surface plane 20 with the vehicle are represented. In addition, specific positions 107 on the vehicle and the assigned fording limits 108 can be represented in a highlighted manner.

What is claimed is:

1. A driver assistance system for determining a fording situation of a vehicle, the system comprising:
a distance sensor, wherein the distance sensor is configured to determine an instantaneous distance from an installation position of the distance sensor to a water surface;
a roll angle sensor, wherein the roll angle sensor is configured to determine an instantaneous roll angle of the vehicle;
a pitch angle sensor, wherein the pitch angle sensor is configured to determine an instantaneous pitch angle of the vehicle; and
a processor, wherein the processor is configured to determine an instantaneous water surface plane based on the instantaneous distance, the instantaneous roll angle, and the instantaneous pitch angle determined by the distance, roll angle, and pitch angle sensors.

2. The driver assistance system of claim 1, further comprising a memory in which respective assigned fording limits for respective ones of a plurality of specific positions on the vehicle are stored, wherein the processor is configured to determine for each of the specific positions whether the assigned fording limit is situated above or below the instantaneous water surface plane.

3. The driver assistance system of claim 1, further comprising a memory in which respective assigned fording limits for respective ones of a plurality of specific positions on the vehicle are stored, wherein the processor is configured to determine for each of the specific positions an instantaneous distance of the respective assigned fording limit from the instantaneous water surface plane for each of the specific positions.

4. The driver assistance system of claim 1, further comprising at least one camera, wherein the at least one camera is configured to detect at least one specific feature of a body of the vehicle, wherein the processor is configured to identify, by evaluating a feature detected in an image obtained from the at least one camera, whether a portion of the body including the feature is situated below the water surface.

5. The driver assistance system of claim 1, further comprising a display via which the driver assistance system is configured to output a representation of the determined instantaneous water surface plane relative to a representation of the vehicle.

6. The driver assistance system of claim 5, further comprising a memory in which respective assigned fording limits for respective ones of a plurality of specific positions on the vehicle are stored, wherein the processor is configured to:
determine for each of the specific positions whether the assigned fording limit is situated above or below the instantaneous water surface plane; and
output via the display a warning responsive to the instantaneous distance of one or more of the specific positions from the respective assigned fording limit being below a predefined threshold.

7. The driver assistance system of claim 5, wherein the representations of the vehicle and the instantaneous water surface plane are at least one of perspective and three-dimensional representations.

8. The driver assistance system of claim 5, further comprising a memory in which respective assigned fording limits for respective ones of a plurality of specific positions on the vehicle are stored, wherein the processor is configured to output via the display:
a visually highlighted intersecting line at which an outer contour of the vehicle intersects the determined instantaneous water surface plane; and
a representation of respective instantaneous distances of the specific positions from the respective assigned fording limits.

9. The driver assistance system of claim 1, wherein the distance sensor is an ultrasonic, LIDAR, or radar sensor.

10. A vehicle comprising a driver assistance system for determining a fording situation of a vehicle, the system comprising:
a distance sensor, wherein the distance sensor is configured to determine an instantaneous distance from an installation position of the distance sensor to a water surface;
a roll angle sensor, wherein the roll angle sensor is configured to determine an instantaneous roll angle of the vehicle;
a pitch angle sensor, wherein the pitch angle sensor is configured to determine an instantaneous pitch angle of the vehicle; and
a processor, wherein the processor is configured to determine an instantaneous water surface plane based on the instantaneous distance, the instantaneous roll angle, and the instantaneous pitch angle determined by the distance, roll angle, and pitch angle sensors.

11. The vehicle of claim 10, wherein the distance sensor is situated on a side mirror of the vehicle.

12. The vehicle of claim 10, wherein the distance sensor is situated at a rear of the vehicle.

13. The vehicle of claim 12, wherein the distance sensor is situated in or on a roof of the vehicle.

14. The vehicle of claim 10, wherein the distance sensor is situated at a front of the vehicle.

15. The vehicle of claim 14, wherein the distance sensor is situated in or on a hood of the vehicle.

16. The vehicle of claim 10, wherein:
the driver assistance system further comprises a memory in which respective assigned fording limits for respective ones of a plurality of specific positions on the vehicle are stored;
the processor is configured to determine for each of the specific positions whether the assigned fording limit is situated above or below the instantaneous water surface plane; and
the specific positions of the vehicle include positions having air intakes.

17. A method for determining a fording situation of a vehicle, the method comprising:
determining an instantaneous roll angle of the vehicle;
determining an instantaneous pitch angle of the vehicle;
using a distance sensor, determining an instantaneous distance from an installation position of the distance sensor to a water surface; and
determining an instantaneous water surface plane based on the determined instantaneous distance, instantaneous roll angle, and instantaneous pitch angle.

18. The method of claim 17, further comprising outputting via a display a representation of the determined instantaneous water surface plane relative to a representation of the vehicle.

19. The method of claim 18, wherein the representations of the vehicle and the instantaneous water surface plane are at least one of perspective and three-dimensional representations.

20. The method of claim 17, wherein respective assigned fording limits are assigned to respective ones of a plurality of specific positions on the vehicle, and the method further comprises determining for each of the specific positions whether the respective assigned fording limit is situated above or below the instantaneous water surface plane.

21. The method of claim 17, wherein:
respective fording limits are assigned to respective ones of a plurality of specific positions on the vehicle; and
the method further comprises:
determining for each of the specific positions whether the assigned fording limit is situated above or below the instantaneous water surface plane; and
outputting a warning responsive to the instantaneous distance of one or more of the specific positions from the respective assigned fording limit being below a predefined threshold.

22. The method of claim 17, further comprising identifying, by evaluating a feature of a body of the vehicle detected in an image obtained from a camera, whether a portion of the body including the feature is situated below the water surface.

23. The method of claim 17, wherein:
respective fording limits are assigned to respective ones of a plurality of specific positions on the vehicle; and
the method further comprises displaying:
a visually highlighted intersecting line at which an outer contour of the vehicle intersects the determined instantaneous water surface plane; and
a representation of respective instantaneous distances of the specific positions from the respective assigned fording limits.

24. A non-transitory computer-readable medium on which are stored instructions that are executable by a processor and that, when executed by the processor, causes the processor to perform a method for determining a fording situation of a vehicle, the method comprising:
determining an instantaneous roll angle of the vehicle;
determining an instantaneous pitch angle of the vehicle;
using a distance sensor, determining an instantaneous distance from an installation position of the distance sensor to a water surface; and
determining an instantaneous water surface plane based on the determined instantaneous distance, instantaneous roll angle, and instantaneous pitch angle.
